(19) United States
(12) Patent Application Publication
(10) Pub. No.: US 2021/0109801 A1
(43) Pub. Date: Apr. 15, 2021

(54) ANOMALY ASSESSMENT DEVICE, ANOMALY ASSESSMENT METHOD, AND STORAGE MEDIUM WHEREUPON ANOMALY ASSESSMENT PROGRAM IS RECORDED

(71) Applicant: NEC Corporation, Tokyo (JP)

(72) Inventors: Masato YASUDA, Tokyo (JP); Yoshiaki SAKAE, Tokyo (JP); Hiroki TAGATO, Tokyo (JP); Shuichi KARINO, Tokyo (JP); Kazuhiko ISOYAMA, Tokyo (JP); Yuji KOBAYASHI, Tokyo (JP)

(73) Assignee: NEC Corporation, Tokyo (JP)

(21) Appl. No.: 16/464,555

(22) PCT Filed: Nov. 17, 2017
(86) PCT No.: PCT/JP2017/041398

§ 371 Date: May 28, 2019

(30) Foreign Application Priority Data
Nov. 29, 2016 (JP) 2016-231394

(51) Int. Cl. G06F 11/07

(52) U.S. Cl. CPC G06F 11/079; G06N 20/00; G06F 11/0775; G06F 11/0751

(57) ABSTRACT

An anomaly assessment device includes: a storage storing a correspondence relation between a type of a device, and a transition state candidate group in a stable state of the device of the type; at least one memory storing instructions; and at least one processor configured to execute the instructions to: acquire event information of a monitoring target device; identify a transition state associated with the event information acquired of the monitoring target device; and assesse normality/anomaly of the monitoring target device, based on the transition state candidate group associated with a type of the monitoring target device in the stored correspondence relation, and the identified transition state.

### TECHNICAL FIELD

One aspect of the present invention relates to an anomaly assessment device, an anomaly assessment method, and a storage medium whereupon an anomaly assessment program is recorded.

### BACKGROUND ART

An anomaly detection device which performs anomaly detection of a monitoring target system is suggested (e.g., PTL 1). An event analysis system as an anomaly detection device disclosed in this PTL 1 acquires an event series by collecting a log from a monitoring target system, and analyzing the collected log. Then, the event analysis system learns a local prediction model which locally predicts a change of an event from the acquired event series. Then, the event analysis system detects an anomaly of a monitoring target system, based on the learned local prediction model and an observed event.

### CITATION LIST

### Patent Literature

[PTL 1] Japanese Unexamined Patent Application Publication No. 2016-99938

[PTL 2] Japanese Unexamined Patent Application Publication No. 2014-32657

### SUMMARY OF INVENTION

### Technical Problem

However, a long time is needed for a learning period for learning a model from a log collected in the event analysis system as an anomaly detection device in PTL 1 described above. This learning period becomes a wasteful resource for a user in which anomaly detection processing cannot be performed, and there is a problem that convenience for a user deteriorates. Moreover, in the event analysis system as an anomaly detection device in PTL 1 described above, it is necessary to learn a model each time a monitoring target system changes, and therefore, there is a possibility that convenience for a user further deteriorates.

An object of one aspect of the present invention is to provide an anomaly assessment device, an anomaly assessment method, and an anomaly assessment program which enable convenience for a user to be improved.

### Solution to Problem

An anomaly assessment device according to a first aspect of the present invention includes:

storage means for storing a correspondence relation between a type of a device, and a transition state candidate group in a stable state of the device of the type;

acquisition means for acquiring event information of a monitoring target device;

identification means for identifying a transition state associated with the event information acquired of the monitoring target device; and

assessment means for assessing normality/anomaly of the monitoring target device, based on the transition state candidate group associated with a type of the monitoring target device in the stored correspondence relation, and the identified transition state.

An anomaly assessment method according to a second aspect of the present invention includes:

acquiring event information of a monitoring target device;

identifying a transition state associated with the event information acquired of the monitoring target device; and

assessing normality/anomaly of the monitoring target device, based on a transition state candidate group associated with a type of the monitoring target device in a correspondence relation between a type of a device and the transition state candidate group in a stable state of the device of the type, and the identified transition state.

An anomaly assessment program according to a third aspect of the present invention, the anomaly assessment program which causes an anomaly assessment device to execute:

processing of acquiring event information of a monitoring target device;

processing of identifying a transition state associated with the event information acquired of the monitoring target device; and

processing of assessing normality/anomaly of the monitoring target device, based on a transition state candidate group associated with a type of the monitoring target device in a correspondence relation between a type of a device and the transition state candidate group in a stable state of the device of the type, and the identified transition state.

### Advantageous Effects of Invention

According to one aspect of the present invention, it is possible to provide an anomaly assessment device, an anomaly assessment method, and an anomaly assessment program which enable convenience for a user to be improved.

### BRIEF DESCRIPTION OF DRAWINGS

FIG. 1 is a diagram illustrating one example of an anomaly assessment system according to a first example embodiment.

FIG. 2 is a block diagram illustrating one example of an anomaly assessment device according to the first example embodiment.

FIG. 3 is a diagram illustrating one example of a correspondence table.

FIG. 4 is a flowchart illustrating one example of a processing operation of the anomaly assessment device according to the first example embodiment.

FIG. 5 is a block diagram illustrating one example of an anomaly assessment device according to a second example embodiment.

FIG. 6 is a diagram illustrating one example of an information management table according to the second example embodiment.

FIG. 7 is a diagram illustrating one example of a state management table according to the second example embodiment.

FIG. 8 is a diagram illustrating a state transition graph corresponding to the state management table in FIG. 7.

FIG. 9 is a flowchart illustrating one example of a processing operation of an anomaly assessment device according to a third example embodiment.

FIG. 10 is a flowchart illustrating one example of a processing operation of the anomaly assessment device according to the third example embodiment.

FIG. 11 is a flowchart illustrating one example of a processing operation of the anomaly assessment device according to the third example embodiment.

FIG. 12 is a block diagram illustrating one example of an anomaly assessment device according to a fourth example embodiment.

FIG. 13 is a diagram illustrating one example of an information management table according to the fourth example embodiment.

FIG. 14 is a flowchart illustrating one example of a processing operation of the anomaly assessment device according to the fourth example embodiment.

FIG. 15 is a flowchart illustrating one example of a processing operation of the anomaly assessment device according to the fourth example embodiment.

FIG. 16 is a flowchart illustrating one example of a processing operation of the anomaly assessment device according to the fourth example embodiment.

FIG. 17 is a flowchart illustrating one example of a processing operation of the anomaly assessment device according to the fourth example embodiment.

FIG. 18 is a diagram illustrating one example of a hardware configuration of an anomaly assessment device.

### EXAMPLE EMBODIMENT

Hereinafter, example embodiments will be described with reference to the drawings. Note that a same reference sign is given to a same element in the example embodiments, and a repeated explanation is omitted.

### First Example Embodiment

Overview of Anomaly Assessment System

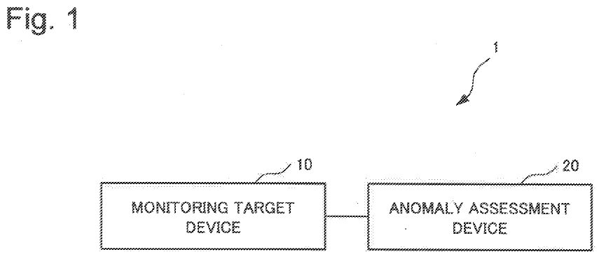

FIG. 1 is a diagram illustrating one example of an anomaly assessment system according to a first example embodiment. In FIG. 1, an anomaly assessment system 1 includes a monitoring target device 10 and an anomaly assessment device 20. The monitoring target device 10 and the anomaly assessment device 20 may be connected to each other in a wired or wireless way. Note that a number of monitoring target devices 10 included in the anomaly assessment system 1 is one, and a number of anomaly assessment devices 20 is one in order to simplify description in FIG. 1, but a number of devices is not limited thereto. For example, the anomaly assessment device 20 may monitor a plurality of monitoring target devices 10.

In the anomaly assessment system 1 in FIG. 1, the monitoring target device 10 monitors a state of the monitoring target device 10 itself, and transmits the monitored state to the anomaly assessment device 20 as “event information”. For example, a “state of the monitoring target device 10 itself” is a “transition state” of an application operating on the monitoring target device 10.

The anomaly assessment device 20 acquires the event information transmitted from the monitoring target device 10. Then, the anomaly assessment device 20 identifies a transition state corresponding to the event information acquired. Moreover, the anomaly assessment device 20 stores a “correspondence relation” between a plurality of types of devices, and a transition state candidate group (hereinafter, referred to as a “state candidate group” in some cases) in a stable state of a device of each type. For example, the anomaly assessment device 20 holds, as a “correspondence relation”, a correspondence table associating a plurality of types of devices with a transition state candidate group in a stable state of a device of each type. Herein, a “stable state” of a device is a state in which the device is stably operating without any anomaly.

Then, the anomaly assessment device 20 assesses normality/anomaly of the monitoring target device 10, based on a transition state candidate group associated with a type of a monitoring target device 10 in a stored “correspondence relation”, and a transition state identified by use of the event information. For example, the anomaly assessment device 20 assesses normality/anomaly of the monitoring target device 10, based on whether a transition state identified by use of the event information is included in a transition state candidate group associated with a type of a monitoring target device 10 in a stored “correspondence relation”.

As described above, in the anomaly assessment system 1, the anomaly assessment device 20 assesses normality/anomaly of the monitoring target device 10, based on the “correspondence relation” stored in advance. Thus, since a “learning period” for identifying a “correspondence relation” becomes unnecessary, it is possible to exclude a wasteful resource in which the anomaly assessment device 20 cannot perform processing of detecting an anomaly of the monitoring target device 10, and, as a result, convenience for a user can be improved. Moreover, the “correspondence relation” associates a plurality of types of devices with a transition state candidate group in a stable state of a device of each type. Thus, even when the monitoring target device 10 is changed from a device of one type to a device of another type, it is not necessary to provide a “learning period” for the device of the another type, and, as a result, convenience for a user can be further improved.

Configuration Example of Anomaly Assessment Device

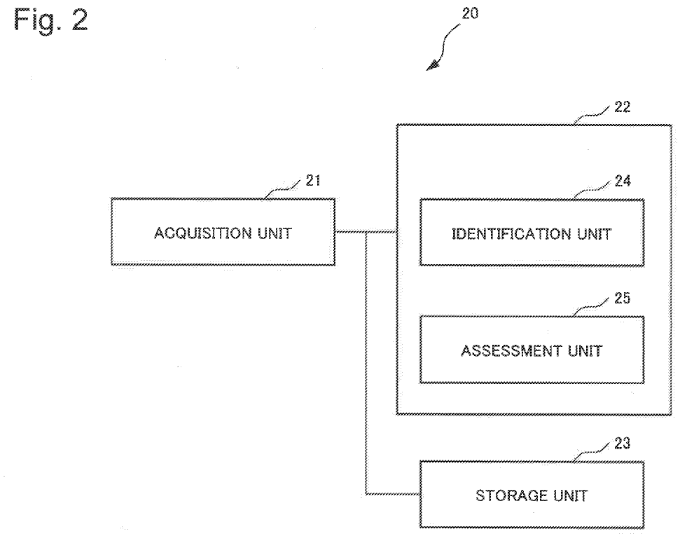

FIG. 2 is a block diagram illustrating one example of the anomaly assessment device according to the first example embodiment. In FIG. 2, the anomaly assessment device 20 includes an acquisition unit 21, a control unit 22, and a storage unit 23. The control unit 22 includes an identification unit 24 and an assessment unit 25.

The acquisition unit 21 acquires event information transmitted from the monitoring target device 10. For example, when the monitoring target device 10 and the anomaly assessment device 20 are connected to each other in a wired way, the acquisition unit 21 is a wired interface, and when the monitoring target device 10 and the anomaly assessment device 20 are connected to each other in a wireless way, the acquisition unit 21 is a wireless interface. Then, the acquisition unit 21 outputs the event information acquired to the identification unit 24.

The identification unit 24 identifies a “transition state” corresponding to the event information of the monitoring target device 10 acquired by the acquisition unit 21. A “transition state” is, for example, a state of an application operating on the monitoring target device 10.

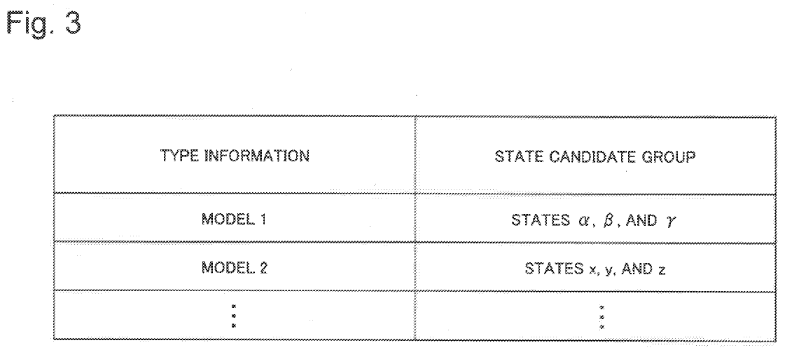

The storage unit 23 stores a “correspondence table” associating a plurality of types of devices with a transition state candidate group in a stable state of a device of each type. FIG. 3 is a diagram illustrating one example of a correspondence table. As illustrated in FIG. 3, an entry exists for a device of each type in the correspondence table. In FIG. 3, a “model” of a device is used as information indicating a type of a device. In a topmost entry in FIG. 3, a model 1 is associated with a state α, a state β, and a state γ as a transition state candidate group in a stable state of a device of the model 1.

The assessment unit 25 assesses normality/anomaly of the monitoring target device 10, based on a transition state candidate group associated with a type of a monitoring target device 10 in a “correspondence relation” stored in the storage unit 23, and a transition state identified by use of event information in the identification unit 24. For example, the assessment unit 25 assesses normality/anomaly of the monitoring target device 10, based on whether a transition state identified by the identification unit 24 is included in a transition state candidate group (i.e., a state candidate group) associated with a type of a monitoring target device 10 in a correspondence table stored in the storage unit 23.

Specifically, the assessment unit 25 acquires model information of the monitoring target device 10 transmitted from the monitoring target device 10 together with event information, identifies an entry corresponding to the acquired model information in a correspondence table stored in the storage unit 23, and further identifies a state candidate group of the specified entry. Then, the assessment unit 25 assesses normality/anomaly of the monitoring target device 10, based on whether a transition state identified by the identification unit 24 is included in the identified state candidate group. For example, when a model of the monitoring target device 10 is the model 1, and a state transition indicated by event information is a state x, the state x is not included in a state candidate group (i.e., the state α, the state β, and the state γ) corresponding to the model 1, and therefore, the assessment unit 25 assesses that the monitoring target device 10 is anomalous. On the other hand, when a model of the monitoring target device 10 is the model 1, and a state transition indicated by event information is a state γ, the state γ is included in a state candidate group (i.e., the state α, the state β, and the state γ) corresponding to the model 1, and therefore, the assessment unit 25 assesses that the monitoring target device 10 is normal.

Operation Example of Anomaly Assessment Device

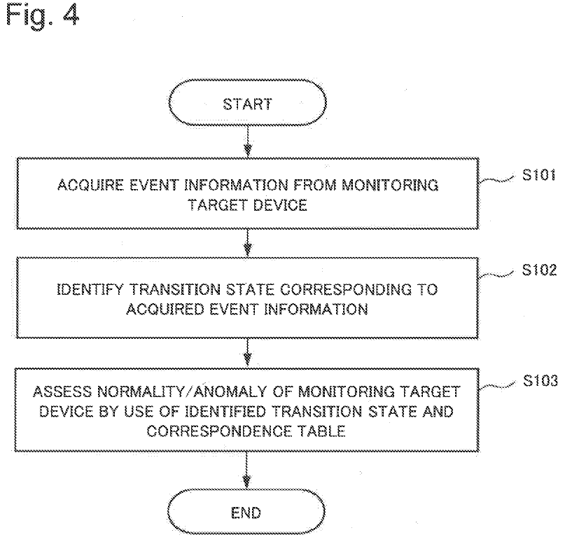

One example of a processing operation of the anomaly assessment device 20 including the above-described configuration is described. FIG. 4 is a flowchart illustrating one example of a processing operation of the anomaly assessment device according to the first example embodiment.

In the anomaly assessment device 20, the acquisition unit 21 acquires event information transmitted from the monitoring target device 10 (step S101).

Then, the identification unit 24 identifies a transition state corresponding to the event information of the monitoring target device 10 acquired by the acquisition unit 21 (step S102).

Then, the assessment unit 25 assesses normality/anomaly of the monitoring target device 10, based on whether a transition state identified by the identification unit 24 is included in a transition state candidate group (i.e., a state candidate group) associated with a type of a monitoring target device 10 in a correspondence table stored in the storage unit 23 (step S103).

As described above, according to the first example embodiment, in the anomaly assessment device 20, the acquisition unit 21 acquires event information transmitted from the monitoring target device 10. The identification unit 24 identifies a transition state corresponding to the event information acquired by the acquisition unit 21. The storage unit 23 stores a “correspondence relation” between a plurality of types of devices, and a transition state candidate group in a stable state of a device of each type. Then, the assessment unit 25 assesses normality/anomaly of the monitoring target device 10, based on a transition state candidate group associated with a type of a monitoring target device 10 in the correspondence relation stored in the storage unit 23, and a transition state identified by use of event information in the identification unit 24. For example, the assessment unit 25 assesses normality/anomaly of the monitoring target device 10, based on whether a transition state identified by use of event information in the identification unit 24 is included in a transition state candidate group associated with a type of a monitoring target device 10 in a correspondence relation stored in the storage unit 23.

According to the configuration of this anomaly assessment device 20, since normality/anomaly of the monitoring target device 10 is assessed based on a correspondence relation stored in advance, a learning period for identifying a correspondence relation becomes unnecessary. Thus, it is possible to exclude a wasteful resource in which the anomaly assessment device 20 cannot perform processing of detecting an anomaly of the monitoring target device 10, and, as a result, convenience for a user can be improved. Moreover, the above-described correspondence relation associates a plurality of types of devices with a transition state candidate group in a stable state of a device of each type. Thus, even when the monitoring target device 10 is changed from a device of one type to a device of another type, it is not necessary to provide a learning period for the device of the another type, and, as a result, convenience for a user can be further improved.

### Second Example Embodiment

In a second example embodiment, a “correspondence relation” between a plurality of types of devices, and a transition state candidate group in a stable state of a device of each type is managed by two tables being an “information management table” and a “state management table”. Moreover, in the “state management table”, each “transition state candidate” is managed as a combination of a state (node) before transition, a state (node) after transition, and transition from a state before transition to a state after transition. Note that, a basic configuration of an anomaly assessment system according to the second example embodiment is the same as that in the first example embodiment, and therefore, is described with reference to FIG. 1.

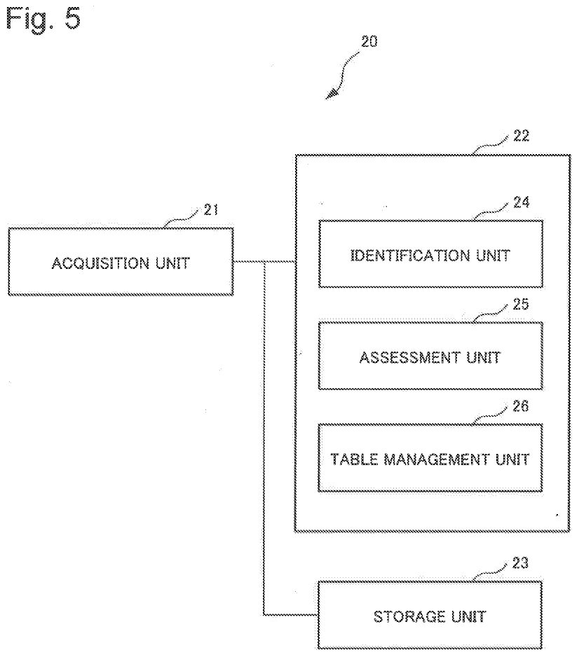

FIG. 5 is a block diagram illustrating one example of an anomaly assessment device according to the second example embodiment. In FIG. 5, a control unit 22 of an anomaly assessment device 20 according to the second example embodiment includes a table management unit 26. This table management unit 26 manages an “information management table” and a “state management table”.

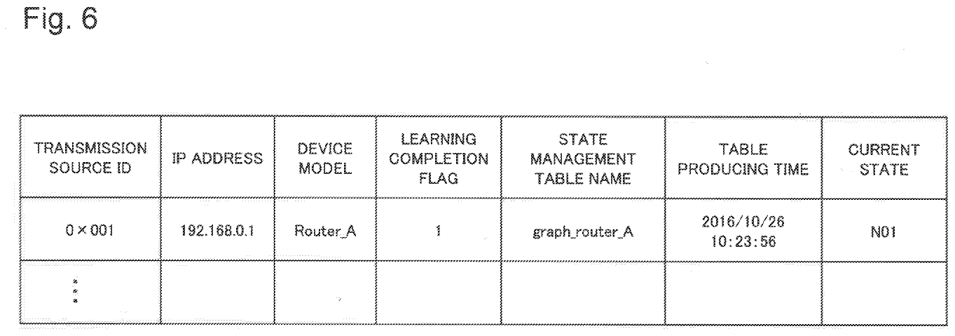

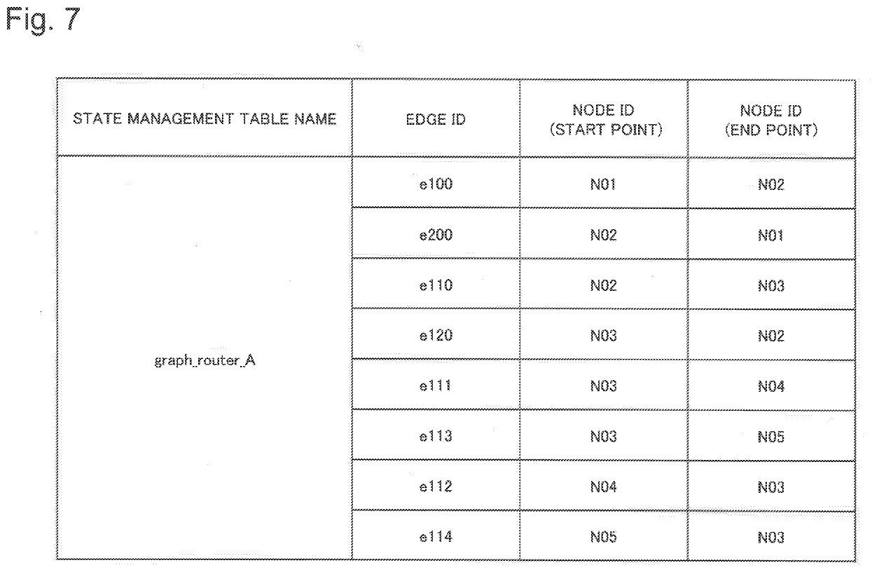

A storage unit 23 according to the second example embodiment holds an “information management table” and a “state management table”. FIG. 6 is a diagram illustrating one example of an information management table according to the second example embodiment. FIG. 7 is a diagram illustrating one example of a state management table according to the second example embodiment.

As illustrated in FIG. 6, an information management table includes, as items, a transmission source ID, an IP address, a device model, a learning completion flag, a state management table name, a table producing time, and a current state. One entry is illustrated as one example in FIG. 6. A device model (i.e., model information) is one example of a device type. This entry indicates that an ID of a terminal (i.e., a monitoring target device) being a transmission source is “0x001”, an IP address of the terminal is “192.168.0.1”, a model of the terminal is “Router_A”, a learning completion flag is “1” indicating that a learning period is already completed, a state management table name corresponding to this entry is “graph_router_A”, a table producing time is “2016/10/26 10:23:56”, and a current state of the terminal is “N01”. Contents of an item “current state” of an entry are updated by the table management unit 26 with an identified transition state each time a transition state of a transmission source terminal corresponding to the entry is identified by an identification unit 24.

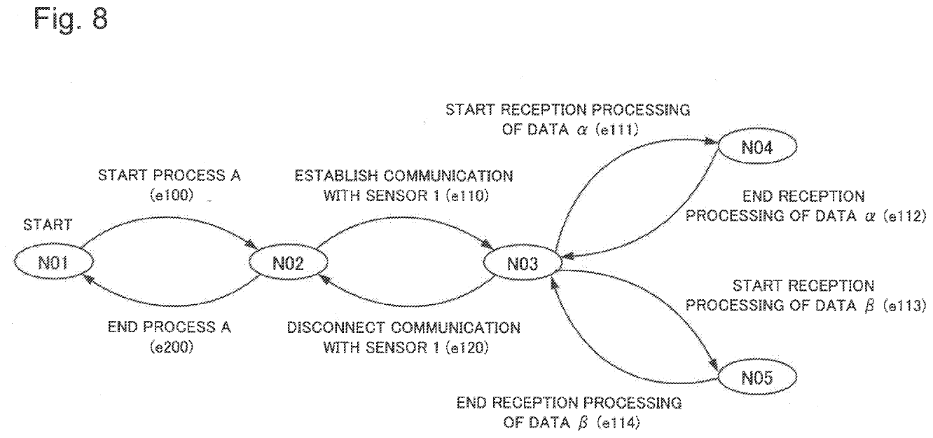

Then, one example of a state management table having a table name “graph_router_A” is illustrated in FIG. 7. As illustrated in FIG. 7, a state management table includes, as items, an edge ID, a node ID (start point), and a node ID (end point). An edge ID is an ID indicating transition from a state before transition to a state after transition, a node ID (start point) is an ID indicating a state (node) before transition, and a node ID (end point) is an ID indicating a state (node) after transition. In other words, the state management table illustrated in FIG. 7 is a table in which a state transition graph illustrated in FIG. 8 is divided into transition units and then put together. FIG. 8 is a diagram illustrating a state transition graph corresponding to the state management table in FIG. 7.

An assessment unit 25 according to the second example embodiment assesses normality/anomaly of a monitoring target device 10, for example, as follows.

First, an acquisition unit 21 acquires an IP address and type information (herein, model information) from the monitoring target device 10 together with event information.

The assessment unit 25 first assesses whether an entry coincident with the IP address acquired by the acquisition unit 21 exists in an information management table.

When an entry coincident with the IP address acquired by the acquisition unit 21 exists in an information management table, the assessment unit 25 holds contents of an item “current state” of the entry as a state before transition. The assessment unit 25 also holds, as a state after transition, a transition state identified by the identification unit 24 from the event information acquired by the acquisition unit 21. Then, by control of the assessment unit 25, the table management unit 26 updates the item “current state” of the entry with the state after transition. Then, the assessment unit 25 assesses whether a combination of the held state before transition and state after transition is entered in a table corresponding to contents of an item “state management table name” of the entry. When the combination is entered, the assessment unit 25 assesses that the monitoring target device 10 is normal. On the other hand, when the combination is not entered, the assessment unit 25 assesses that the monitoring target device 10 is anomalous.

When an entry coincident with the IP address acquired by the acquisition unit 21 does not exist in an information management table, the table management unit 26 adds a new entry (hereinafter, referred to as an “additional entry” in some cases) to the information management table, by control of the assessment unit 25. Then, the assessment unit 25 assesses whether an entry coincident with the type information acquired by the acquisition unit 21 exists in an information management table. When an entry coincident with the type information acquired by the acquisition unit 21 exists in an information management table, the table management unit 26 inputs contents of an item “state management table name” of the entry to an item “state management table name” of the additional entry, by control of the assessment unit 25. In this instance, the table management unit 26 sets contents of an item “learning completion flag” to “1”, by control of the assessment unit 25. Then, the assessment unit 25 assesses normality/anomaly of the monitoring target device 10 by use of a table corresponding to this state management table name. Note that, when an entry coincident with the type information acquired by the acquisition unit 21 does not exist in an information management table, the assessment unit 25 may control in such a way as to output a report signal reporting this fact to a user, or may control in such a way as to execute “processing of a learning period” described later in a third example embodiment.

In this way, it is possible to improve accuracy of normality/anomaly assessment of the monitoring target device 10 by managing a combination of a state before transition and a state after transition in a stable state. In other words, for example, as illustrated in FIG. 8, N01 to N05 exist as a transition state candidate group in a stable state of a certain device. According to management of a transition state candidate according to the second example embodiment, even when a current transition state is included in N01 to N05, a combination in which a state before transition is N04 and a state after transition is N05, for example, is not held in the information management table in FIG. 7. As a result, the monitoring target device 10 is assessed to be anomalous by the assessment unit 25, and normality/anomaly assessment is performed with a severer criterion.

As described above, according to the second example embodiment, in the anomaly assessment device 20, the storage unit 23 stores a “correspondence relation” between a plurality of types of devices, and a transition state candidate group in a stable state of a device of each type, and each “transition state candidate” is a combination of a state before transition and a state after transition. Then, the assessment unit 25 assesses normality/anomaly of the monitoring target device 10, based on whether a combination of a current transition state identified by use of event information in the identification unit 24 and a preceding transition state exists in a transition state candidate group associated with a type of a monitoring target device 10 in a correspondence relation stored in the storage unit 23.

According to the configuration of this anomaly assessment device 20, it is possible to further improve accuracy of normality/anomaly assessment of the monitoring target device 10.

### Third Example Embodiment

The third example embodiment mainly relates to processing of a “learning period” for identifying a “correspondence relation” between a plurality of types of devices, and a transition state candidate group in a stable state of a device of each type. Note that, basic configurations of an anomaly assessment system, a monitoring target device, and an anomaly assessment device according to the third example embodiment are the same as those according to the second example embodiment, and therefore, are described with reference to FIGS. 1, and 5 to 8.

Configuration Example of Anomaly Assessment Device

A table management unit 26 of an anomaly assessment device 20 according to the third example embodiment generates an “additional entry” in an information management table by use of event information, an IP address, and type information (herein, model information) acquired by an acquisition unit 21 in a “learning period”. In this instance, the table management unit 26 generates a “state management table name” by use of model information, and inputs the state management table name to the additional entry. Moreover, the table management unit 26 sets contents of an item “learning completion flag” of the additional entry to “0”. Then, the table management unit 26 generates a state management table corresponding to the generated “state management table name”.

Then, an assessment unit 25 identifies a state before transition and a state after transition each time event information is acquired from a monitoring target device 10 corresponding to the above-described additional entry in the acquisition unit 21 in a “learning period”. Then, when a combination of the identified state before transition and state after transition is not yet registered on the above-described generated state management table, the table management unit 26 registers the combination on the state management table as a new entry, by control of the assessment unit 25. Processing of this “learning period” is executed in the stable state of a monitoring target device 10. In this way, a “correspondence relation” between a plurality of types of devices, and a transition state candidate group in a stable state of a device of each type is identified in a learning period. Herein, when a learning period ends, the table management unit 26 sets contents of the item “learning completion flag” of the above-described additional entry to “1”, by control of the assessment unit 25.

After this correspondence relation is identified, when the anomaly assessment device 20 acquires event information from another monitoring target device 10 of a same type as the monitoring target device 10, the table management unit 26 generates an entry of an information management table and a state management table of the another monitoring target device 10 by use of an already generated information management table and state management table corresponding to a same type, by control of the assessment unit 25. Then, the assessment unit 25 is able to assess normality/anomaly of the another monitoring target device 10 by use of the generated entry of the information management table and state management table of the another monitoring target device 10. Thus, it is possible to assess normality/anomaly of another monitoring target device 10, based on a correspondence relation already stored with regard to a device of a same type, and therefore, a learning period for identifying a correspondence relation regarding the another monitoring target device 10 becomes unnecessary. Thus, it is possible to exclude a wasteful resource in which the anomaly assessment device 20 cannot perform processing of detecting an anomaly of the another monitoring target device 10, and, as a result, convenience for a user can be improved.

Operation Example of Anomaly Assessment Device

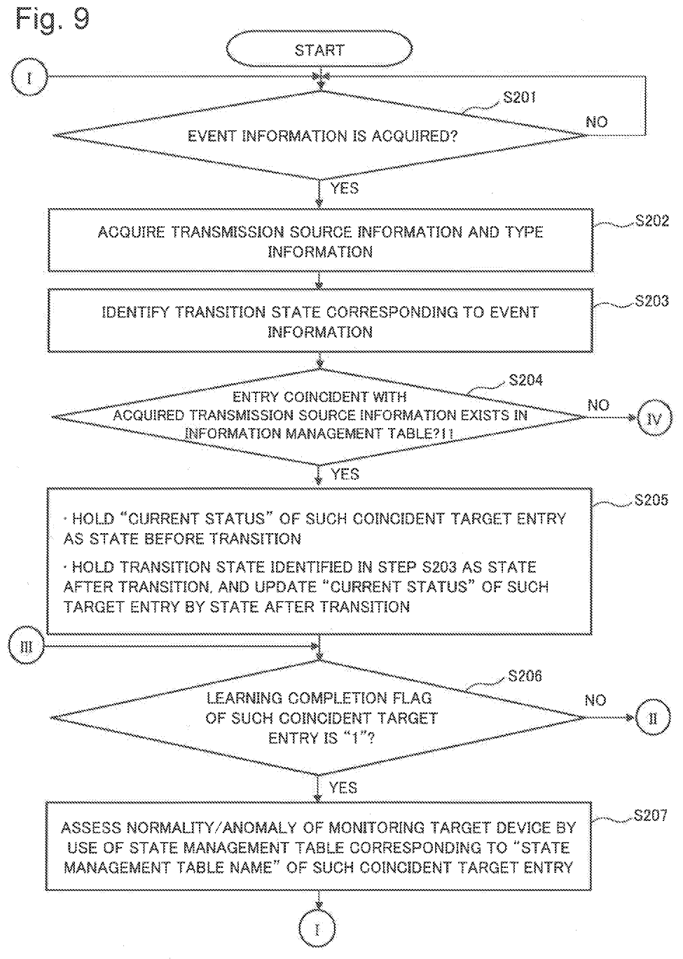

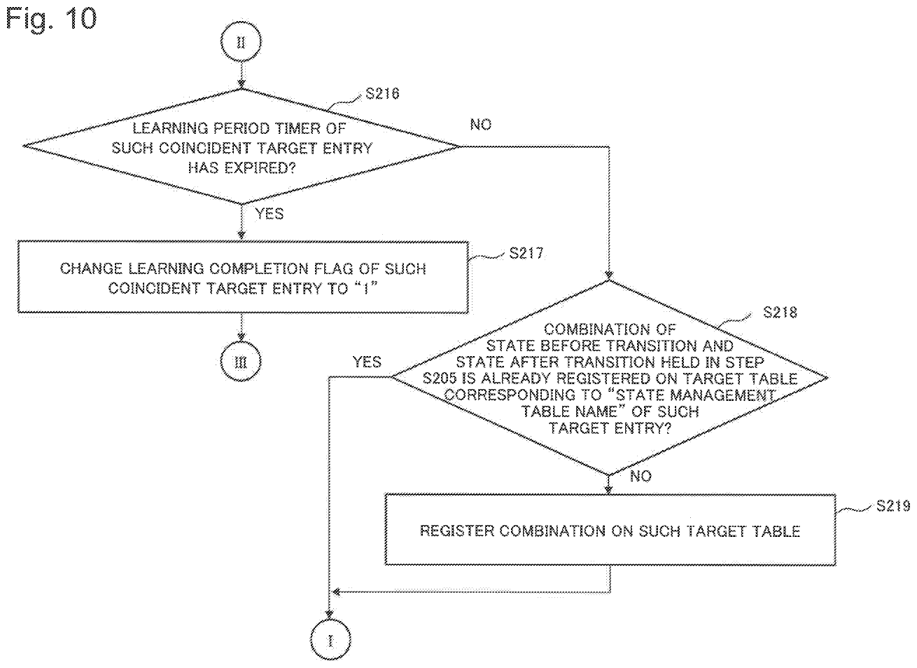

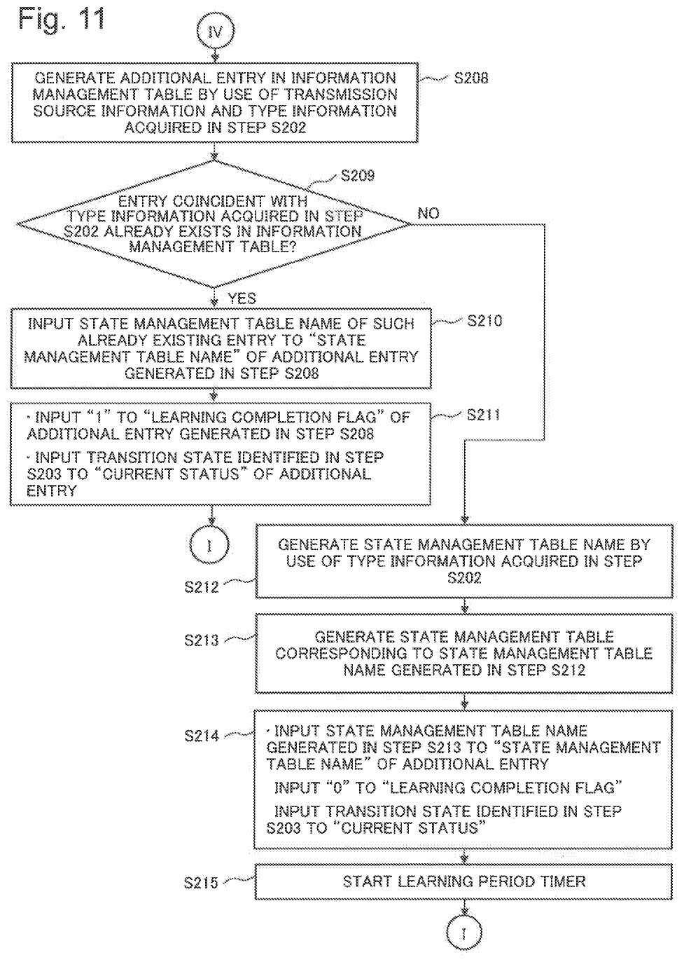

One example of a processing operation of the anomaly assessment device 20 according to the third example embodiment including the above-described configuration is described. FIGS. 9 to 11 are flowcharts illustrating one example of a processing operation of an anomaly assessment device according to the third example embodiment. FIGS. 10 and 11 are flowcharts following FIG. 9.

The assessment unit 25 of the anomaly assessment device 20 according to the third example embodiment waits until event information from the monitoring target device 10 is acquired by the acquisition unit 21 (NO in step S201).

When event information is acquired by the acquisition unit 21 (YES in step S201), the assessment unit 25 acquires transmission source information (an IP address, a session ID, and the like) and type information acquired by the acquisition unit 21 together with the event information (step S202).

Furthermore, an identification unit 24 identifies a transition state corresponding to the event information acquired by the acquisition unit 21 (step S203).

Then, the assessment unit 25 assesses whether an entry coincident with the acquired transmission source information exists in an information management table (step S204).

When an entry coincident with the acquired transmission source information exists in an information management table (YES in step S204), the assessment unit 25 holds contents of an item “current status” of the target entry as a state before transition, further holds the transition state identified in the step S203 as a state after transition, controls the table management unit 26, and thus updates the contents of the item “current status” of the target entry by a state after transition (step S205).

Then, the assessment unit 25 assesses whether a learning completion flag of the target entry is “1” indicating that a learning period is already completed (step S206).

When a learning completion flag of the target entry is “1” (YES in step S206), the assessment unit 25 assesses normality/anomaly of the monitoring target device 10 by use of a state management table corresponding to contents of an item “state management table name” of the target entry (step S207). This assessment processing of normality/anomaly can be performed as in the second example embodiment. Then, the processing step returns to the step S201.

In contrast, when a learning completion flag of the target entry is “0” (NO in step S206), the assessment unit 25 assesses whether a learning period timer has expired (step S216).

Then, when the learning period timer has expired (YES in step S216), the assessment unit 25 controls the table management unit 26, and thus changes the learning completion flag of the target entry to “1” (step S217). Then, the processing step returns to the step S206.

On the other hand, when the learning period timer has not expired (NO in step S216), the assessment unit 25 assesses whether a combination of a state before transition and a state after transition held in the step S205 is already registered on a table corresponding to contents of an item “state management table name” of the target entry (step S218).

When a combination is not registered yet (NO in step S218), the assessment unit 25 controls the table management unit 26, and thus registers a combination of a state before transition and a state after transition held in the step S205, on a table corresponding to contents of an item “state management table name” of the target entry (step S219). Then, the processing step returns to the step S201. On the other hand, when a combination is already registered (YES in step S218), the processing step returns to the step S201.

On the other hand, when an entry coincident with the acquired transmission source information does not exist in an information management table (NO in step S204), the assessment unit 25 controls the table management unit 26, and thus generates an additional entry in the information management table by use of the transmission source information, the type information, and the like acquired in the step S202 (step S208).

Then, the assessment unit 25 assesses whether an entry coincident with the type information acquired in the step S202 already exists in an information management table (step S209).

When an entry coincident with the type information acquired in the step S202 already exists in an information management table (YES in step S209), the assessment unit 25 controls the table management unit 26, thus inputs a state management table name of the already existing entry to an item “state management table name” of the additional entry generated in the step S208 (step S210).

Further, the assessment unit 25 controls the table management unit 26, thus inputs “1” to an item “learning completion flag” of the additional entry generated in the step S208, and also inputs the transition state identified in the step S203 to an item “current status” of the additional entry (step S211). Then, the processing step proceeds to the step S201.

When an entry coincident with the type information acquired in the step S202 does not exist in an information management table yet (NO in step S209), the assessment unit 25 controls the table management unit 26, and thus generates a state management table name by use of the type information acquired in the step S202 (step S212).

Then, the assessment unit 25 controls the table management unit 26, and thus generates a state management table corresponding to the state management table name generated in the step S212 (step S213).

Then, the assessment unit 25 controls the table management unit 26, thus inputs the state management table name generated in the step S213 to an item “state management table name” of the additional entry, inputs “0” to the item “learning completion flag”, and inputs the transition state identified in the step S203 to the item “current status” (step S214). Then, the assessment unit 25 starts the learning period timer (step S215). Then, the processing step returns to the step S201. Herein, by setting the item “learning completion flag” of the additional entry to “0”, the “learning period” of the monitoring target device 10 corresponding to this additional entry is started.

As described above, according to the third example embodiment, in the anomaly assessment device 20, before acquiring event information of a monitoring target device 10, the assessment unit 25 assesses normality/anomaly of the monitoring target device 10 by use of a correspondence relation identified by a type of another monitoring target device 10 in a stable state and a plurality of transition states identified in a stable state of the another monitoring target device 10.

According to the configuration of this anomaly assessment device 20, it is possible to assess normality/anomaly of the monitoring target device 10, based on a correspondence relation already stored with regard to a device of a same type, and therefore, a learning period for identifying a correspondence relation regarding the monitoring target device 10 becomes unnecessary. Thus, it is possible to exclude a wasteful resource in which the anomaly assessment device 20 cannot perform processing of detecting an anomaly of the monitoring target device 10, and, as a result, convenience for a user can be improved.

### Fourth Example Embodiment

When a type coincident with type information acquired from a monitoring target device is not included in a correspondence relation, but a type having coincident model information in type information is included in a correspondence relation, a fourth example embodiment uses, for normality/anomaly assessment of the monitoring target device, a transition state candidate group corresponding to a type of which similarity distance representing a similarity to the acquired type information is less than or equal to a predetermined threshold value, and which has a smallest similarity distance.

Note that, a basic configuration of an anomaly assessment system according to the fourth example embodiment is the same as that according to the third example embodiment, and therefore, is described with reference to FIG. 1.

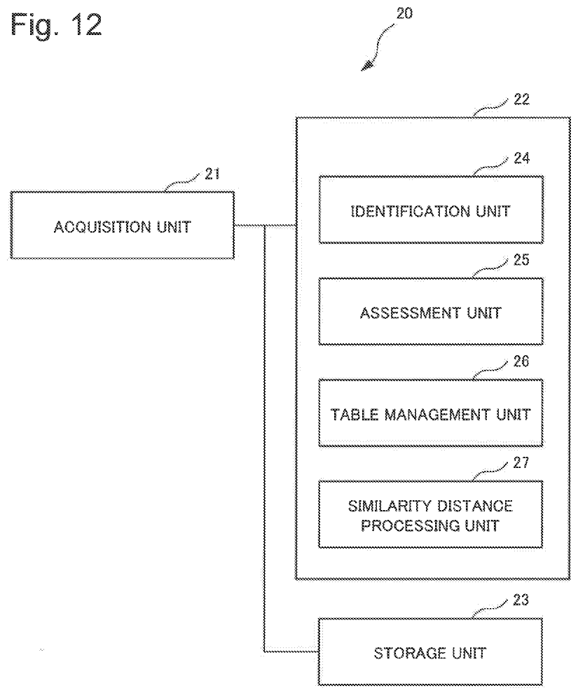

Configuration Example of Anomaly Assessment Device FIG. 12 is a block diagram illustrating one example of an anomaly assessment device according to the fourth example embodiment. In FIG. 12, a control unit 22 of an anomaly assessment device 20 according to the fourth example embodiment includes a similarity distance processing unit 27.

As in the first to third example embodiments, an acquisition unit 21 of the anomaly assessment device 20 according to the fourth example embodiment acquires transmission source information (an IP address, a session ID, and the like) and type information from a monitoring target device 10 together with event information. However, in the fourth example embodiment, type information includes at least either a “use condition” or a “use setting” of the monitoring target device 10, in addition to model information. Hereinafter, type information is described as including all of model information, a use condition, and a use setting. A use condition is a peripheral condition in which the monitoring target device 10 is used, and includes, for example, a condition in which both a temperature sensor and a pressure sensor exist under the monitoring target device 10, a condition in which only a temperature sensor exists, a condition in which only a pressure sensor exists, and the like. Moreover, a use setting is an internal condition of the monitoring target device 10, and includes, for example, a version of an application, and the like.

When an entry which is not totally coincident with type information transmitted from the monitoring target device 10 together with event information, but is coincident with model information included in the type information exists in an information management table, an assessment unit 25 of the anomaly assessment device 20 according to the fourth example embodiment controls the similarity distance processing unit 27, and thus calculates a “similarity distance” between the type information acquired by the acquisition unit 21, and type information of each of the coincident entries. Calculation of this similarity distance will be described in detail later.

Then, when an entry satisfying a “predetermined condition” in relation to the calculated similarity distance exists, the assessment unit 25 applies a state management table of the entry satisfying the predetermined condition to normality/anomaly assessment for the monitoring target device 10 being a transmission source of the event information, transmission source information, and type information acquired by the acquisition unit 21. In other words, the assessment unit 25 reuses an already existing state management table. The above-described “predetermined condition” refers to, for example, a minimum value among similarity distances calculated with regard to respective entries, and indicates that the minimum value is less than or equal to a “predetermined threshold value”.

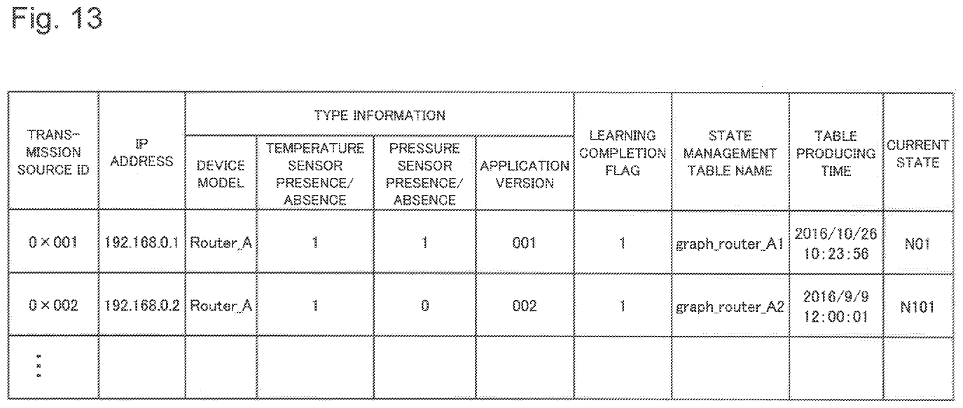

Herein, calculation of a similarity distance is described. FIG. 13 is a diagram illustrating one example of an information management table according to the fourth example embodiment. For a monitoring target device corresponding to a topmost entry in FIG. 13, an item “transmission source ID” is “0x001”, an item “device model” in type information is “Router_A”, items “temperature sensor presence/absence” and “pressure sensor presence/absence” are both “1” indicating “present”, and an item “application version” is “001”. Moreover, for a monitoring target device corresponding to a second entry from the top, an item “transmission source ID” is “0x002”, an item “device model” in type information is “Router_A”, an item “temperature sensor presence/absence” is “1” indicating “present”, an item “pressure sensor presence/absence” is “0” indicating “absent”, and an item “application version” is “002”.

Then, it is assumed that, in the acquisition unit 21, the following type information is acquired from the monitoring target device 10 having a transmission source ID “0x003” together with event information. In the type information, an item “device model” is “Router_A”, items “temperature sensor presence/absence” and “pressure sensor presence/absence” are both “1” indicating “present”, and an item “application version” is “003”.

In this instance, with regard to, for example, each entry coincident with model information of type information acquired by the acquisition unit 21, the similarity distance processing unit 27 calculates, as a “similarity distance”, a number of operations that can make the acquired type information coincide with type information of each entry, i.e., a number of type parameters differing between the acquired type and type information of each entry. In other words, for a similarity distance relating to the topmost entry in FIG. 13, only a type parameter “application version” differs between type information of the entry and the acquired type information, and therefore, a similarity distance becomes “1”. Similarly, a similarity distance relating to the second entry in FIG. 13 becomes “2”. Herein, assuming that the above-described predetermined threshold value is “1”, “graph_router_A1” being a state management table of the topmost entry is reused as a state management table of the monitoring target device 10 having the transmission source ID “0x003”. Note that, each type parameter is equally treated in the above description, but may be weighted. In other words, each operation of a similarity may be weighted, and thus a similarity distance may be calculated in consideration of the weight. For example, “3” may be added to a similarity distance when a type parameter “temperature sensor presence/absence” differs, “2” may be added to a similarity distance when “pressure sensor presence/absence” differs, and “1” may be added to a similarity distance when “application version” differs. In this case, a similarity distance relating to the second entry from the top in FIG. 13 becomes “3”.

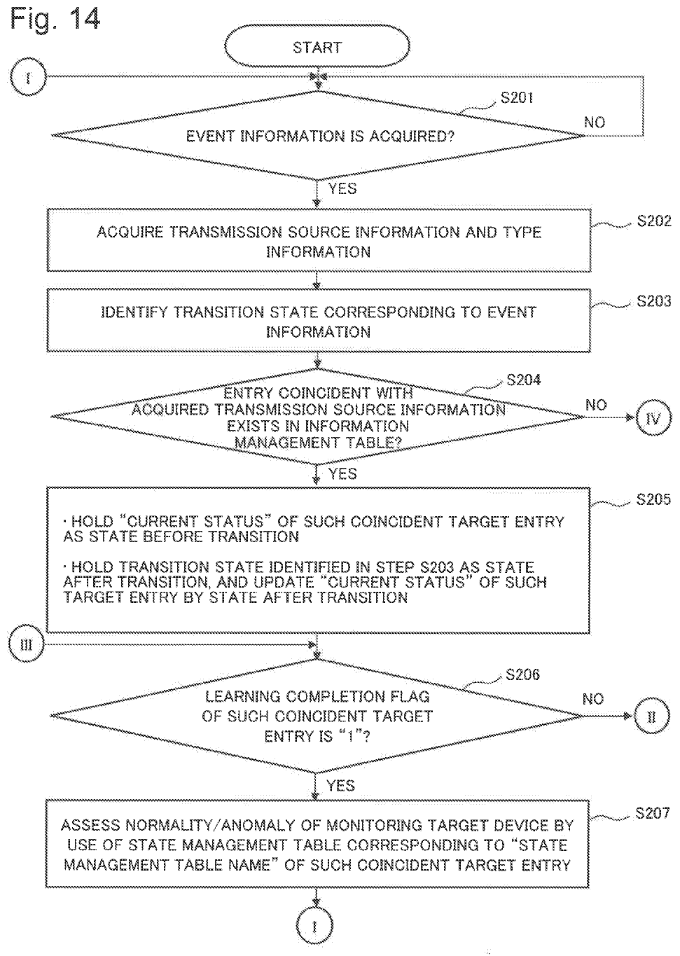

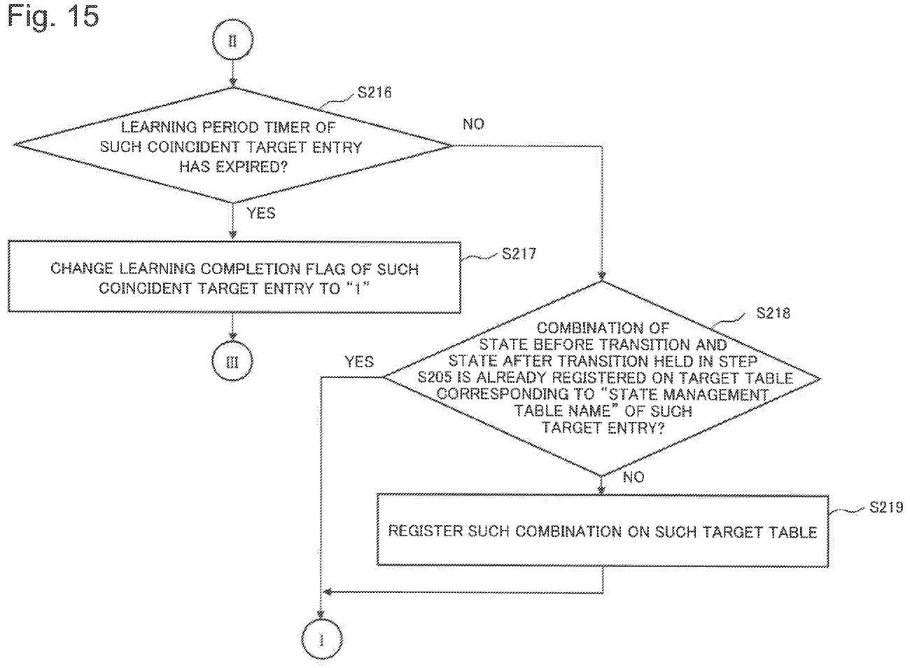

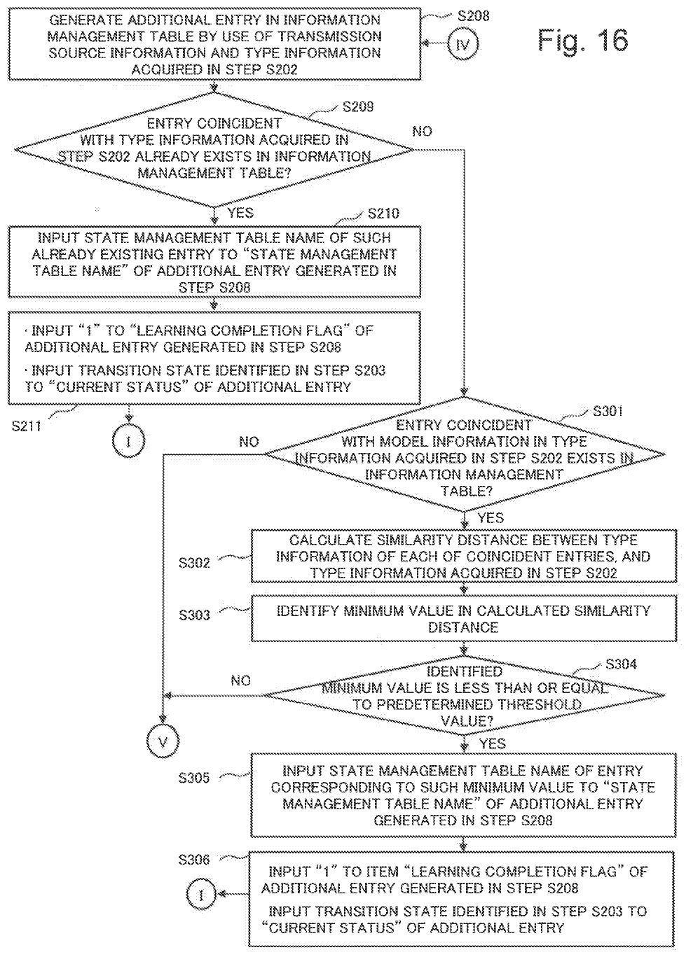

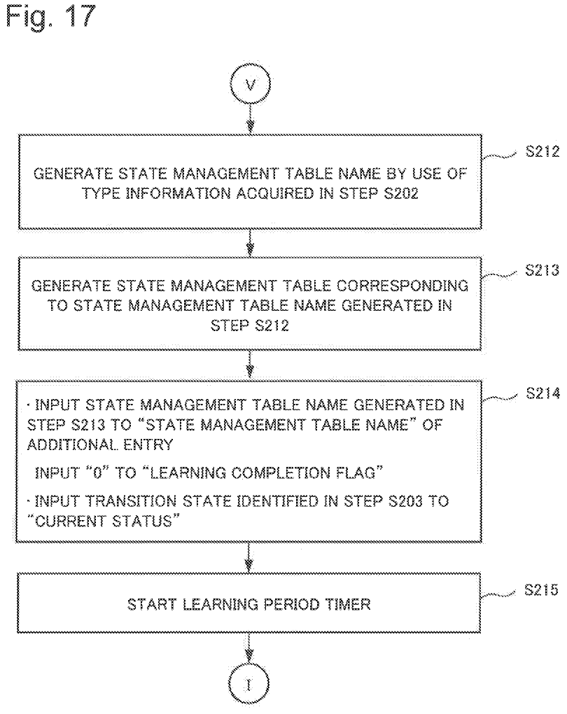

Operation Example of Anomaly Assessment Device One example of a processing operation of the anomaly assessment device 20 according to the fourth example embodiment including the above-described configuration is described. FIGS. 14 to 17 are flowcharts illustrating one example of a processing operation of an anomaly assessment device according to the fourth example embodiment. FIGS. 15 to 17 are flowcharts following FIG. 14. In FIGS. 14 to 17, same reference signs are given to processing steps equivalent to processing steps in FIGS. 9 to 11 in the third example embodiment. FIGS. 14 and 15 are the same as FIGS. 9 and 10, respectively.

When an entry coincident with type information acquired in a step S202 does not exist in an information management table yet (NO in step S209), the assessment unit 25 assesses whether an entry coincident with model information in type information acquired in the step S202 exists in an information management table (step S301).

When an entry coincident with model information in type information acquired in the step S202 exists in an information management table (YES in step S301), the assessment unit 25 controls the similarity distance processing unit 27, and thus calculates a “similarity distance” between type information of each of the coincident entries, and the type information acquired in the step S202 (step S302).

Then, the assessment unit 25 identifies a minimum value in at least one similarity distance calculated by the similarity distance processing unit 27 (step S303), and assesses whether the identified minimum value is less than or equal to a predetermined threshold value (step S304).

When the identified minimum value is less than or equal to the predetermined threshold value (YES in step S304), the assessment unit 25 controls a table management unit 26, and thus inputs a state table name of an entry corresponding to the minimum value to an item “state management table name” of an additional entry generated in a step S208 (step S305).

Then, the assessment unit 25 controls the table management unit 26, thus inputs “1” to an item “learning completion flag” of the additional entry generated in the step S208, and inputs a transition state identified in a step S203 to an item “current status” of the additional entry (step S306). Then, the processing step proceeds to a step S201. Note that, when an entry coincident with model information in type information acquired in the step S202 does not exist in the information management table (NO in step S301), and when an identified minimum value is more than the predetermined threshold value (NO in step S304), the processing step proceeds to a step S212.

As described above, according to the fourth example embodiment, the assessment unit 25 of the anomaly assessment device 20 calculates a similarity distance representing a similarity to an item parameter of a type of a monitoring target device 10 in relation to an item parameter (i.e., a type parameter) of each type included in a correspondence relation stored in a storage unit 23, and uses a transition state candidate group corresponding to a type having a similarity distance being less than or equal to a predetermined threshold value and being smallest among a calculated plurality of similarity distances.

According to the configuration of this anomaly assessment device 20, it is possible to reuse, for normality/anomaly assessment for the monitoring target device 10, a correspondence relation of a type having a difference being less than or equal to a certain level even when all type parameters are not coincident, and therefore, it is possible to reduce a probability that a learning period becomes necessary for the monitoring target device 10. Thus, it is possible to maximally exclude a wasteful resource in which the anomaly assessment device 20 cannot perform processing of detecting an anomaly of the monitoring target device 10, and, as a result, convenience for a user can be improved.

### Other Example Embodiments

(1) Although descriptions have been given in the first to fourth example embodiments assuming that a “correspondence relation” stored in the storage unit 23 is a correspondence relation between a plurality of types of devices, and a transition state candidate group in a stable state of a device of each type, one aspect of the present invention is not limited to this. For example, one type may be included in a “correspondence relation” stored in the storage unit 23. In other words, a “correspondence relation” stored in the storage unit 23 may be a correspondence relation between a type of a device, and a transition state candidate group in a stable state of the device of the type.

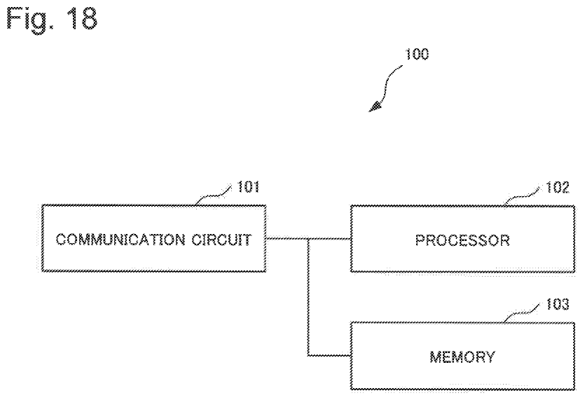

(2) The anomaly assessment device 20 according to each of the first to fourth example embodiments may have the following hardware configuration. FIG. 18 is a diagram illustrating one example of a hardware configuration of an anomaly assessment device.

In FIG. 18, an anomaly assessment device 100 includes a communication circuit 101, a processor 102, and a memory 103.

The acquisition unit 21 of the anomaly assessment device 20 described in each of the first to fourth example embodiments is implemented by the communication circuit 101. Moreover, the control unit 22 of the anomaly assessment device 20 described in each of the first to fourth example embodiments is implemented by the processor 102 by reading and then executing a program stored in the memory 103.

Some or all of the above-described example embodiments may be also described as, but are not limited to, the following supplementary notes.

### (Supplementary Note 1)

An anomaly assessment device including:

a storage unit which stores a correspondence relation between a type of a device, and a transition state candidate group in a stable state of the device of the type;

an acquisition unit which acquires event information of a monitoring target device; and

an identification unit which identifies a transition state associated with the event information acquired of the monitoring target device; and an assessment unit which assesses normality/anomaly of the monitoring target device, based on the transition state candidate group associated with a type of the monitoring target device in the stored correspondence relation, and the identified transition state.

### (Supplementary Note 2)

The anomaly assessment device according to Supplementary note 1, wherein

the assessment unit assesses normality/anomaly of the monitoring target device, based on whether the identified transition state is included in the transition state candidate group associated with a type of the monitoring target device in the stored correspondence relation.

### (Supplementary Note 3)

The anomaly assessment device according to Supplementary note 1 or 2, wherein

the correspondence relation is identified by a type of another monitoring target device being in a stable state, and a plurality of transition states identified in a stable state of the another monitoring target device, before event information of the monitoring target device is acquired.

### (Supplementary Note 4)

The anomaly assessment device according to any one of Supplementary notes 1 to 3, wherein

each transition state candidate in the correspondence relation is a combination of a state before transition and a state after transition, and

the assessment unit assesses normality/anomaly of the monitoring target device, based on whether a combination of a current transition state identified by the identification unit, and a transition state preceding the current transition state is included in the transition state candidate group associated with a type of the monitoring target device in the stored correspondence relation.

### (Supplementary Note 5)

The anomaly assessment device according to any one of Supplementary notes 1 to 4, wherein

a type of the device in the correspondence relation includes at least one of a use condition and a use setting of the device.

### (Supplementary Note 6)

The anomaly assessment device according to any one of Supplementary notes 1 to 5, wherein

the correspondence relation stored in the storage unit is a correspondence relation between a plurality of types of a device, and the transition state candidate group in a stable state of a device of each type, and

the assessment unit calculates a similarity distance representing a similarity to an item parameter of a type of the monitoring target device in relation to an item parameter of each type included in the stored correspondence relation, and uses the transition state candidate group associated with a type having a similarity distance being less than or equal to a predetermined threshold value and being smallest among the calculated plurality of similarity distances.

### (Supplementary Note 7)

An anomaly assessment method including:

acquiring event information of a monitoring target device;

identifying a transition state associated with the event information acquired of the monitoring target device; and

assessing normality/anomaly of the monitoring target device, based on a transition state candidate group associated with a type of the monitoring target device in a correspondence relation between a type of a device and the transition state candidate group in a stable state of the device of the type, and the identified transition state.

### (Supplementary Note 8)

The anomaly assessment method according to Supplementary note 7, further including,

in the assessment, assessing normality/anomaly of the monitoring target device, based on whether the identified transition state is included in the transition state candidate group associated with a type of the monitoring target device in the correspondence relation.

### (Supplementary Note 9)

The anomaly assessment method according to Supplementary note 7 or 8, wherein

the correspondence relation is identified by a type of another monitoring target device being in a stable state, and a plurality of transition states identified in a stable state of the another monitoring target device, before event information of the monitoring target device is acquired.

### (Supplementary Note 10)

The anomaly assessment method according to any one of Supplementary notes 7 to 9, wherein

each transition state candidate in the correspondence relation is a combination of a state before transition and a state after transition, and,

in the assessment, normality/anomaly of the monitoring target device is assessed based on whether a combination of the identified current transition state, and a transition state preceding the current transition state is included in the transition state candidate group associated with a type of the monitoring target device in the correspondence relation.

### (Supplementary Note 11)

The anomaly assessment method according to any one of Supplementary notes 7 to 10, wherein

a type of the device in the correspondence relation includes at least one of a use condition and a use setting of the device.

### (Supplementary Note 12)

The anomaly assessment method according to any one of Supplementary notes 7 to 11, wherein

the correspondence relation is a correspondence relation between a plurality of types of a device, and the transition state candidate group in a stable state of a device of each type, and,

in the assessment, a similarity distance representing a similarity to an item parameter of a type of the monitoring target device is calculated in relation to an item parameter of each type included in the correspondence relation, and the transition state candidate group associated with a type having a similarity distance being less than or equal to a predetermined threshold value and being smallest among the calculated plurality of similarity distances is used.

### (Supplementary Note 13)

An anomaly assessment program which causes an anomaly assessment device to execute processing of:

acquiring event information of a monitoring target device;

identifying a transition state associated with the event information acquired of the monitoring target device; and

assessing normality/anomaly of the monitoring target device, based on a transition state candidate group associated with a type of the monitoring target device in a correspondence relation between a type of a device and the transition state candidate group in a stable state of the device of the type, and the identified transition state.

One aspect of the present invention has been described above with above-described example embodiments as exemplary examples. However, one aspect of the present invention is not limited to the above-described example embodiments. In other words, various aspects that can be understood by a person skilled in the art are applicable to the present invention within the scope of the present invention.

This application is based upon and claims the benefit of priority from Japanese Patent Application No. 2016-231394, filed on Nov. 29, 2016, the disclosure of which is incorporated herein in its entirety by reference.

### REFERENCE SIGNS LIST

1 Anomaly assessment system
10 Monitoring target device
20 Anomaly assessment device
21 Acquisition unit
22 Control unit
23 Storage unit
24 Identification unit
25 Assessment unit
26 Table management unit
27 Similarity distance processing unit

1. An anomaly assessment device comprising:
a storage storing a correspondence relation between a type of a device, and a transition state candidate group in a stable state of the device of the type;
at least one memory storing instructions; and
at least one processor configured to execute the instructions to:
acquire event information of a monitoring target device;
identify a transition state associated with the event information acquired of the monitoring target device; and
assesse normality/anomaly of the monitoring target device, based on the transition state candidate group associated with a type of the monitoring target device in the stored correspondence relation, and the identified transition state.

2. The anomaly assessment device according to claim 1,
wherein the at least one processor configured to execute the instructions to assess normality/anomaly of the monitoring target device, based on whether the identified transition state is included in the transition state candidate group associated with a type of the monitoring target device in the stored correspondence relation.

3. The anomaly assessment device according to claim 1,
wherein the correspondence relation is identified by a type of another of the monitoring target device being in a stable state, and a plurality of transition states identified in a stable state of the another monitoring target device, before event information of the monitoring target device is acquired.

4. The anomaly assessment device according to claim 1,
wherein each transition state candidate in the correspondence relation is a combination of a state before transition and a state after transition, and
wherein the at least one processor configured to execute the instructions to assess normality/anomaly of the monitoring target device, based on whether a combination of a current transition state identified, and a transition state preceding the current transition state is included in the transition state candidate group associated with a type of the monitoring target device in the stored correspondence relation.

5. The anomaly assessment device according to claim 1,
wherein a type of the device in the correspondence relation includes at least one of a use condition and a use setting of the device.

6. The anomaly assessment device according to claim 1,
wherein the correspondence relation stored in the storage is a correspondence relation between a plurality of types of a device, and the transition state candidate group in a stable state of a device of each type, and
wherein the at least one processor configured to execute the instructions to:
calculate a similarity distance representing a similarity to an item parameter of a type of the monitoring target device in relation to an item parameter of each type included in the stored correspondence relation; and
use the transition state candidate group associated with a type having a similarity distance being less than or equal to a predetermined threshold value and being smallest among the calculated plurality of similarity distances.

7. An anomaly assessment method comprising:
acquiring event information of a monitoring target device;
identifying a transition state associated with the event information acquired of the monitoring target device; and
assessing normality/anomaly of the monitoring target device, based on a transition state candidate group associated with a type of the monitoring target device in a correspondence relation between a type of a device and the transition state candidate group in a stable state of the device of the type, and the identified transition state.

8. The anomaly assessment method according to claim 7, further comprising,
in the assessment, assessing normality/anomaly of the monitoring target device, based on whether the identified transition state is included in the transition state candidate group associated with a type of the monitoring target device in the correspondence relation.

9. The anomaly assessment method according to claim 7,
wherein the correspondence relation is identified by a type of another of the monitoring target device being in a stable state, and a plurality of transition states identified in a stable state of the another monitoring target device, before event information of the monitoring target device is acquired.

10. The anomaly assessment method according to claim 7,
wherein each transition state candidate in the correspondence relation is a combination of a state before transition and a state after transition, and,
wherein in the assessment, normality/anomaly of the monitoring target device is assessed based on whether a combination of the identified current transition state, and a transition state preceding the current transition state is included in the transition state candidate group associated with a type of the monitoring target device in the correspondence relation.

11. The anomaly assessment method according to claim 7,
wherein a type of the device in the correspondence relation includes at least one of a use condition and a use setting of the device.

12. The anomaly assessment method according to claim 7,
wherein the correspondence relation is a correspondence relation between a plurality of types of a device, and the transition state candidate group in a stable state of a device of each type, and,
wherein in the assessment, a similarity distance representing a similarity to an item parameter of a type of the monitoring target device is calculated in relation to an item parameter of each type included in the correspondence relation, and the transition state candidate group associated with a type having a similarity distance being less than or equal to a predetermined threshold value and being smallest among the calculated plurality of similarity distances is used.

13. A non-transitory computer readable storage medium recording an anomaly assessment program which causes an anomaly assessment device to execute:
processing of acquiring event information of a monitoring target device;
processing of identifying a transition state associated with the event information acquired of the monitoring target device; and
processing of assessing normality/anomaly of the monitoring target device, based on a transition state candidate group associated with a type of the monitoring target device in a correspondence relation between a type of a device and the transition state candidate group in a stable state of the device of the type, and the identified transition state.
